(19) United States
(12) Patent Application Publication
(10) Pub. No.: US 2025/0065692 A1
(43) Pub. Date: Feb. 27, 2025

(54) VEHICLE

(71) Applicant: HONDA MOTOR CO., LTD., Tokyo (JP)

(72) Inventors: Aoi KANNO, Tokyo (JP); Kazuhiro HARUYAMA, Kanagawa (JP)

(73) Assignee: HONDA MOTOR CO., LTD., Tokyo (JP)

(21) Appl. No.: 18/786,001

(22) Filed: Jul. 26, 2024

(30) Foreign Application Priority Data
Aug. 25, 2023 (JP) 2023-137112

(51) Int. Cl. B60H 1/00; B60R 16/02

(52) U.S. Cl. CPC B60H 1/00564; B60R 16/0207

(57) ABSTRACT

A vehicle includes: a case; a power device accommodated in the case; and a cooling mechanism configured to introduce air in a passenger compartment of the vehicle into the case to cool the power device, the cooling mechanism includes an exhaust duct configured to allow the air to be discharged from the case, the exhaust duct includes a first duct portion connected to the case, a second duct portion fixed to a floor panel of the vehicle, and a plate-shaped coupling member coupling the first duct portion and the second duct portion, the second duct portion and the coupling member are fixed as defined herein, the fixing member is fitted in one of the through hole of the second duct portion or the through hole of the coupling member, and the other is longer than the one at least in a width direction of the vehicle.

### CROSS-REFERENCE TO RELATED APPLICATION

This application is based on and claims priority under 35 USC 119 from Japanese Patent Application No. 2023-137112 filed on Aug. 25, 2023.

### TECHNICAL FIELD

The present invention relates to a vehicle in which a power device is cooled by air in a passenger compartment.

### BACKGROUND ART

In recent years, efforts to realize a low carbon social or a decarburized social have been activated, and research and development have been performed on an electrification technique in order to reduce CO₂ emissions and improve energy efficiency even in vehicles.

In a vehicle such as an electric vehicle or a hybrid vehicle using a motor as a drive source, a power device unit accommodating a power device such as a battery is mounted. In this type of vehicle, in order to prevent performance degradation of the power device due to an abnormal temperature increase, the power device is cooled by air drawn from a passenger compartment so as to maintain a temperature of the power device within an appropriate range.

For example, in a vehicle disclosed in JP2021-146801A, air that has cooled a battery is returned to a passenger compartment from an exhaust duct through an extension duct. Further, in the vehicle disclosed in JP2021-146801A, a positional deviation between the exhaust duct and the extension duct in a vehicle width direction is absorbed by an annular and bellows-shaped coupling mechanism provided between the exhaust duct and the extension duct.

### SUMMARY OF INVENTION

However, in the annular and bellows-shaped coupling mechanism, an exhaust path is sealed, and thus a degree of freedom of the exhaust path is low. Meanwhile, it is also necessary to cope with the positional deviation of the exhaust duct in the vehicle width direction.

The present invention provides a vehicle in which a positional deviation of an exhaust duct in a vehicle width direction can be absorbed while improving a degree of freedom of an exhaust path.

The present invention is a vehicle including:
a case;
a power device accommodated in the case; and
a cooling mechanism configured to introduce air in a passenger compartment into the case to cool the power device, in which
the cooling mechanism includes
   an exhaust duct configured to allow the air to be discharged from the case, the exhaust duct includes
   a first duct portion connected to the case,
   a second duct portion fixed to a floor panel of the vehicle, and
   a plate-shaped coupling member coupling the first duct portion and the second duct portion,
the second duct portion and the coupling member are fixed by a fixing member passing through a through hole of the second duct portion and a through hole of the coupling member,
the fixing member is fitted in one of the through hole of the second duct portion or the through hole of the coupling member, and
other of the through hole of the second duct portion or the through hole of the coupling member is longer than the one of the through hole of the second duct portion or the through hole of the coupling member at least in a width direction of the vehicle.

According to the present invention, it is possible to provide a vehicle in which a positional deviation of the exhaust duct in the vehicle width direction can be absorbed while improving a degree of freedom of an exhaust path.

### BRIEF DESCRIPTION OF DRAWINGS

FIG. 1 is a diagram showing a vehicle V according to an embodiment of the present invention in which a battery pack 1 is mounted.

FIG. 2 is a perspective view of the battery pack 1.

FIG. 3 is an exploded perspective view of the battery pack 1.

FIG. 4 is an exploded perspective view of an exhaust duct 53 disposed on a floor panel F of the vehicle V.

FIG. 5 is a plan view of the exhaust duct 53 disposed on the floor panel F of the vehicle V.

FIG. 6 is a cross-sectional view showing a coupling member between a first duct portion 531 and a second duct portion 532 of the exhaust duct 53.

FIG. 7 is a main part plan view showing an exhaust flow path of the exhaust duct 53.

FIG. 8 is a cross-sectional view taken along a line A-A of FIG. 7.

### DETAILED DESCRIPTION OF THE INVENTION

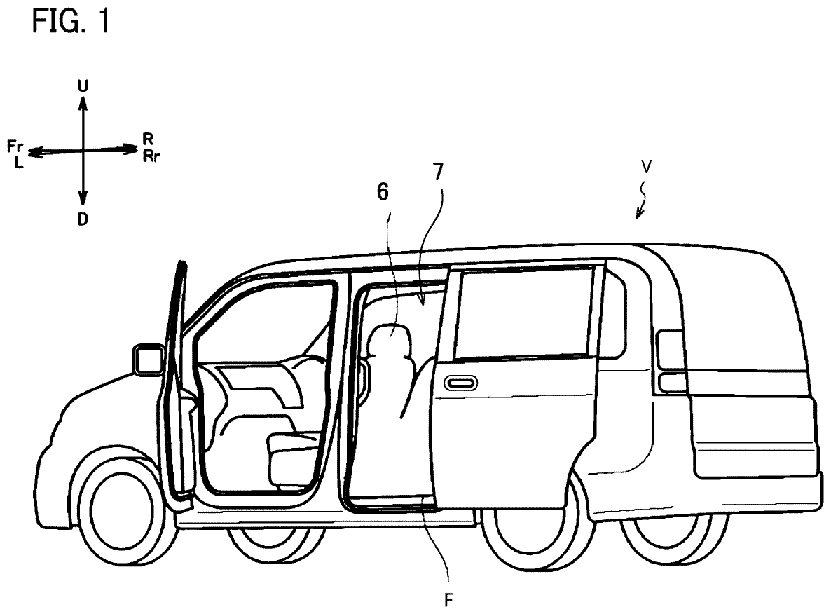

Hereinafter, an embodiment of the present invention will be described with reference to FIGS. 1 to 8. The drawings are to be viewed in the direction of reference signs, and in the following description, front-rear, left-right, and upper-lower directions are referred to as directions seen from a driver, and in the drawings, a front side of the vehicle is shown as Fr, rear side as Rr, left side as L, right side as R, upper side as U, and lower side as D.

### —Vehicle—

As shown in FIG. 1, a vehicle V of the present embodiment is an electric vehicle such as a hybrid vehicle, and is driven by an engine and a motor-generator (not shown).

A battery pack 1 is placed on a floor panel F of the vehicle V at a position below a front seat 6 (that is, a driver seat and a passenger seat) disposed in a passenger compartment 7. For example, the battery pack 1 is accommodated in a recess formed in the floor panel F, and is fixed to the floor panel F or a vehicle frame. The battery pack 1 is connected to the motor-generator via a DC line (not shown).

### —Battery Pack—

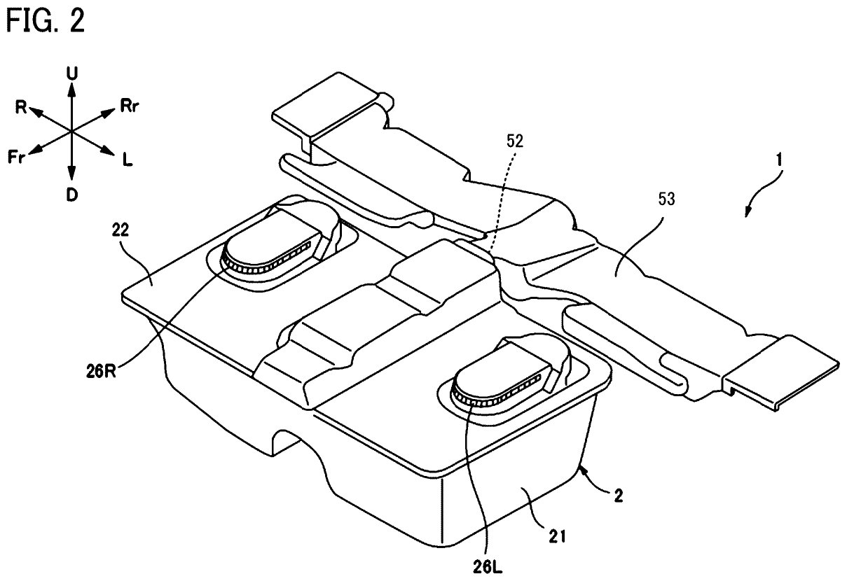

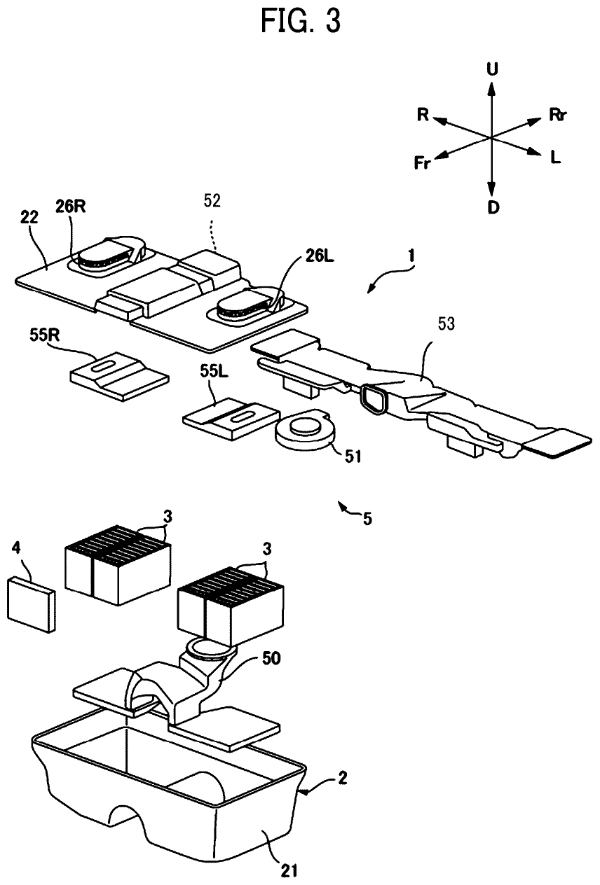

As shown in FIGS. 2 and 3, the battery pack 1 includes a battery case 2; battery modules 3 and an electric device 4 that are accommodated in the battery case 2; and a cooling mechanism 5 that introduces air in the passenger compartment into the battery case 2 to cool the battery modules 3. The electric device 4 is, for example, a battery electronic control unit (ECU), a junction box, or the like.

The battery case 2 includes a case body 21 having a bottomed shape and opened upward, and a lid 22 covering an opening of the case body 21. A plurality of battery modules 3, the electric device 4, and a cooling fan 51 which is a part of the cooling mechanism 5 are accommodated in an internal space of the battery case 2.

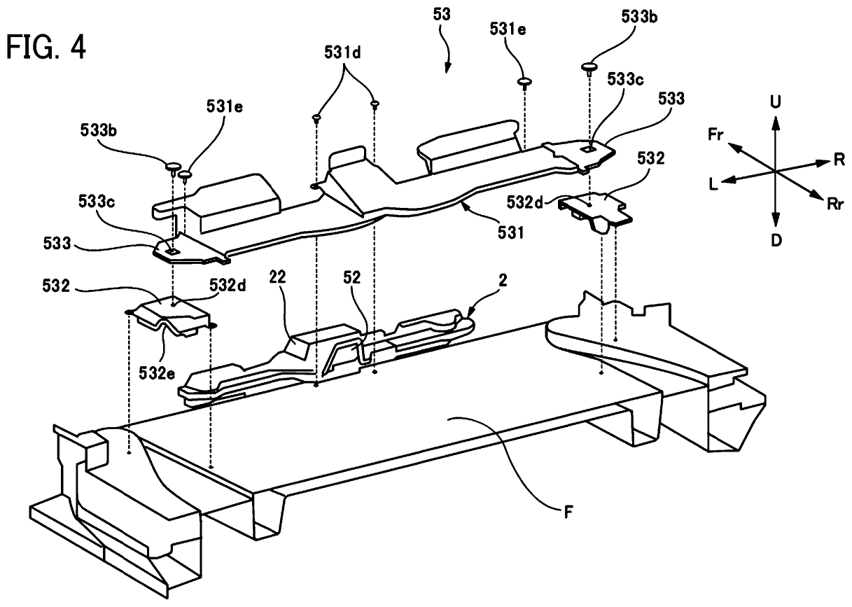

The cooling mechanism 5 includes case intakes 26L, 26R formed in the battery case 2; upstream intake ducts 55L, 55R that guide air in the passenger compartment, that is introduced into the internal space of the battery case 2 through the case intakes 26L, 26R, to the battery modules 3; a downstream intake duct 50 that guides the air that has cooled the battery modules 3 to the cooling fan 51; the cooling fan 51; a case exhaust port 52 that is formed in a rear end portion of the battery case 2 and at a center in a vehicle width direction and allows the air that has cooled the battery modules 3 to be discharged outside the battery case 2; and an exhaust duct 53 that allows the air discharged from the case exhaust port 52 to be discharged into the passenger compartment. Hereinafter, the exhaust duct 53 as a main part of the present invention will be described with reference to FIGS. 4 to 8.

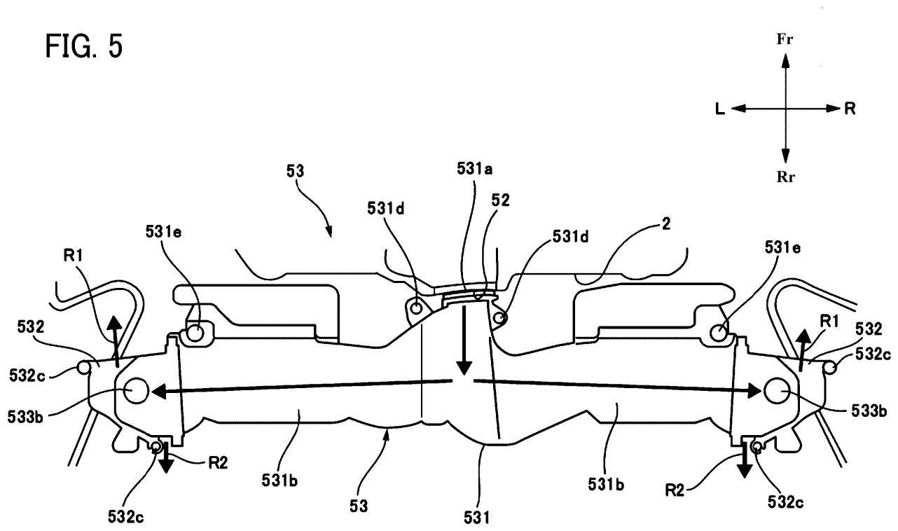

As shown in FIGS. 4 and 5, the exhaust duct 53 includes a first duct portion 531 that is disposed on a rear side of the battery case along the vehicle width direction and is connected to the battery case 2; left and right second duct portions 532 that are disposed on left and right outer sides of the first duct portion 531 and are fixed to the floor panel F; and left and right coupling members 533 that couple the first duct portion 531 and the second duct portions 532.

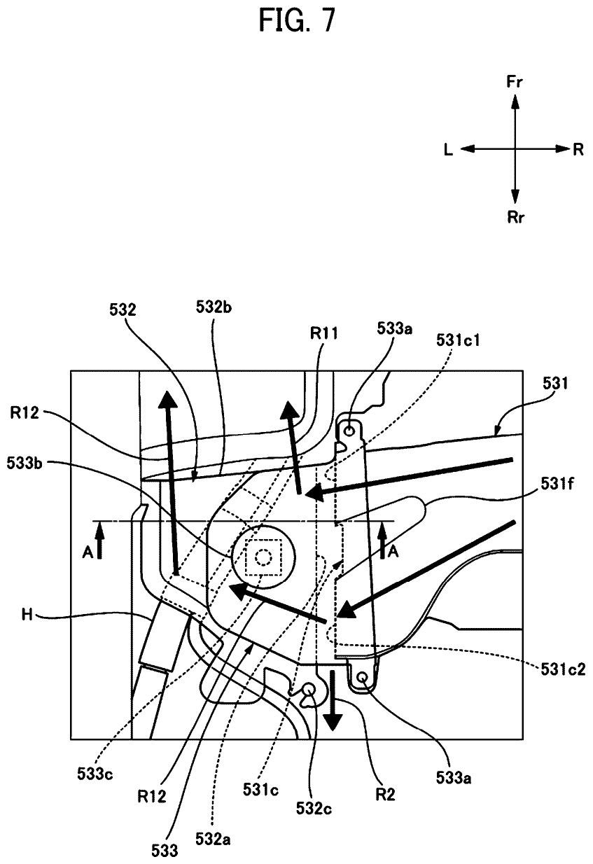

The first duct portion 531 includes an introduction port 531a that is connected to the case exhaust port 52 of the battery case 2 and introduces the air discharged from the case exhaust port 52 into the first duct portion 531; left and right extension portions 531b that extend from the introduction port 531a in the vehicle width direction and guide the air introduced from the introduction port 531a to left and right outer sides; exhaust ports 531c (refer to FIG. 7) that discharge the air to outer sides from tip end portions (outer end portions) of the two extension portions 531b; screw portions 531d that fix the first duct portion 531 to the battery case 2 in a vicinity of the introduction port 531a; and clip portions 531e that fix the first duct portion 531 to the floor panel F on tip end sides of the two extension portions 531b.

The first duct portion 531 of the present embodiment is a flattened tubular member, and constitutes by itself a flow path of the air introduced from the introduction port 531a, but may be a cover member that covers the floor panel F so that a flow path is formed between the first duct portion 531 and the floor panel F.

As shown in FIG. 7, each of the second duct portions 532 includes an introduction port 532a that faces the exhaust port 531c of the first duct portion 531 and introduces the air discharged from the exhaust port 531c into the second duct portion 532; an exhaust port 532b that allows the air introduced from the introduction port 532a to be discharged forward; and a screw portion 532c that fixes the second duct portion 532 to the floor panel F.

The second duct portion 532 of the present embodiment is a cover member that covers the floor panel F so that an air flow path is formed between the second duct portion 532 and the floor panel F, but may be a tubular member that forms an air flow path by itself.

Each of the coupling members 533 is a plate-shaped member that covers an outer end portion of the first duct portion 531 and an inner portion of the second duct portion 532 from above, and couples the first duct portion 531 and the second duct portion 532 by being fixed to the outer end portion of the first duct portion 531 via a screw portion 533a and being fixed to the second duct portion 532 via a clip 533b.

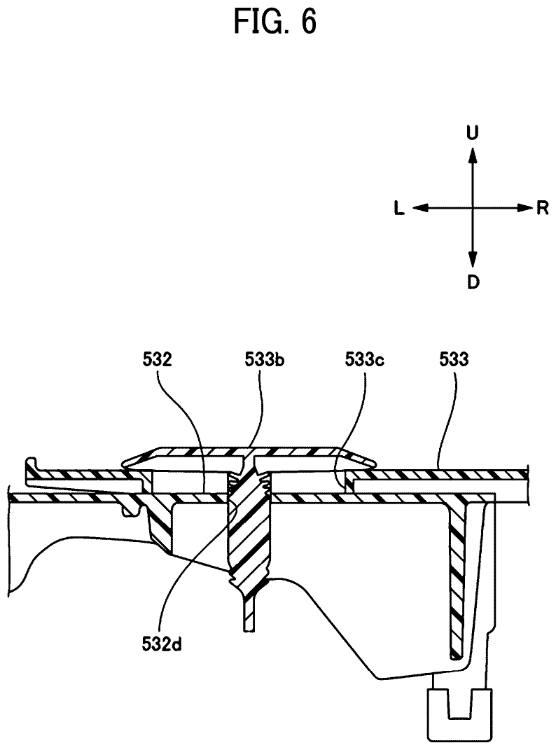

Specifically, as shown in FIG. 6, the clip 533b passes through a through hole 533c of the coupling member 533 and a through hole 532d of the second duct portion 532 from above, and is fitted into the through hole 532d of the second duct portion 532, and thus the coupling member 533 is fixed to the second duct portion 532. The through hole 533c of the coupling member 533 is longer than the through hole 532d of the second duct portion 532 in the vehicle width direction and the front-rear direction.

According to such a configuration, by adopting the plate-shaped coupling member 533, a degree of freedom in forming the flow path is improved, unlike the annular and bellows-shaped coupling member in the conventional art. In addition, positional deviations between the first duct portion 531 and the second duct portion 532 in the vehicle width direction and the front-rear direction can be absorbed by a slide permitting structure formed by the through hole 533c of the coupling member 533. Accordingly, when the coupling member 533 coupled to the first duct portion 531 is attached to the second duct portion 532 fixed to the floor panel F, attachment workability is improved.

In the present embodiment, by setting the through hole 533c of the coupling member 533 to be longer than the through holes 532d of the second duct portion 532 in the vehicle width direction and the front-rear direction, the positional deviations between the first duct portion 531 and the second duct portion 532 in the vehicle width direction and the front-rear direction are absorbed, but the positional deviations between the first duct portion 531 and the second duct portion 532 in the vehicle width direction and the front-rear direction may be absorbed by setting the through hole 532d of the second duct portion 532 to be longer than the through hole 533c of the coupling member 533. In the present embodiment, the positional deviations between the first duct portion 531 and the second duct portion 532 in the vehicle width direction and the front-rear direction can be absorbed, but a direction in which the positional deviation is absorbed may be only the vehicle width direction.

As shown in FIG. 5, the exhaust duct 53 forms a first flow path R1 for discharging the air discharged from the battery case 2 into the passenger compartment through the first duct portion 531 and the second duct portions 532, and a second flow path R2 for discharging the air discharged from the battery case 2 into the passenger compartment through the first duct portion 531 without passing through the second duct portions 532.

According to the exhaust duct 53, the exhaust to the passenger compartment is dispersed, so that discomfort of the occupant due to the exhaust can be reduced. As described above, the second duct portion 532 is a cover member that covers the floor panel F so that the first flow path R1 is formed between the second duct portion 532 and the floor panel F, so that an exhaust area is increased and a flow velocity is decreased, and thus occurrence of abnormal noise can be prevented while appropriately controlling the exhaust gas.

As shown in FIG. 7, the second flow path R2 allows the air, which is discharged from the battery case 2, to be discharged into the passenger compartment through a gap which is covered from above by the coupling member 533 and provided between the first duct portion 531 and the second duct portion 532. In this way, the second flow path R2 can be easily formed.

The first flow path R1 and the second flow path R2 allow the air, which is discharged from the battery case 2, to be discharged to different directions in the front-rear direction of the vehicle V. For example, the first flow path R1 allows the air, which is discharged from the battery case 2, to be discharged toward a vehicle front side, and the second flow path R2 allows the air, that is discharged from the battery case 2, to be discharged toward a vehicle rear side. In this way, the exhaust to the passenger compartment can be reliably dispersed, and discomfort of the occupant due to the exhaust can be reduced.

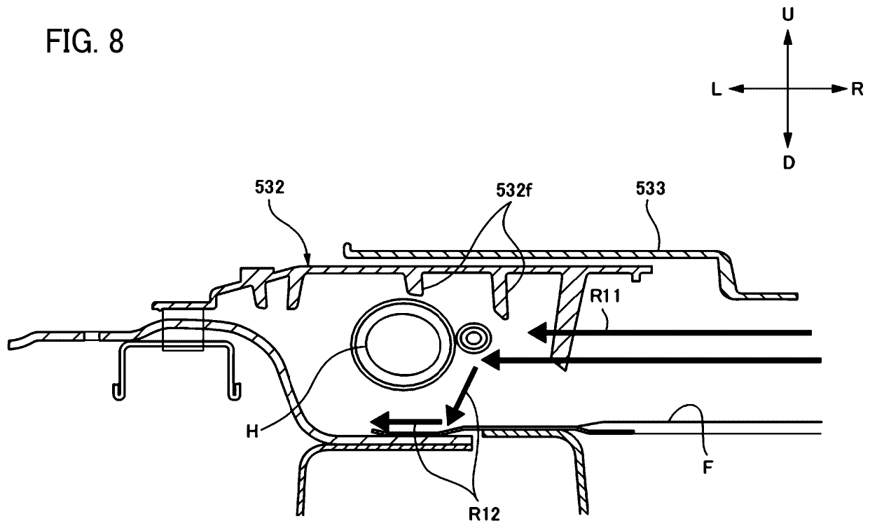

As shown in FIGS. 7 and 8, a harness H is disposed along the front-rear direction of the vehicle V between the second duct portion 532 and the floor panel F. For example, the second duct portion 532 of the present embodiment has, at a rear end portion thereof, a recess 532e (see FIG. 4), and draws the harness H between the second duct portion 532 and the floor panel F via the recess 532e.

A plurality of ribs 532f protruding downward are formed on a lower surface portion of the second duct portion 532, and a routing path of the harness His defined by these ribs 532f. For example, as shown in FIGS. 7 and 8, the harness H of the present embodiment is disposed between the second duct portion 532 and the floor panel F so as to be inclined in a plan view in a way of being closer to an inner side of the vehicle V as approaching a front side of the vehicle V and inclined in a side view in a way of being closer to a lower side as approaching the front side of the vehicle V. In this way, the second duct portion 532 can have a function of supporting the harness H.

The exhaust port 531c of the first duct portion 531 allows the air, which is discharged from the battery case 2, to be discharged toward the harness H. Thus, a direction of the exhaust can be controlled using the harness H. For example, as the air hits the harness H, the first flow path R1 is divided into an inner flow path R11 along which the air passes an inner side (upper side) of the harness and an outer flow path R12 along which the air passes an outer side (lower side) of the harness H. In this way, the exhaust can be further dispersed and the discomfort of the occupant can be further reduced.

Further, the exhaust port 531c of the first duct portion 531 has a branch portion 531f at an intermediate portion in the front-rear direction, and the exhaust port 531c branches into a first exhaust port 531c1 and a second exhaust port 531c2. The first exhaust port 531c1 is located at a front side of the exhaust port 531c and is in communication with the inner flow path R11, and the second exhaust port 531c2 is located on a rear side of the first exhaust port 531c1 and is in communication with the outer flow path R12. Accordingly, the air discharged from the exhaust port 531c of the first duct portion 531 can be reliably dispersed to the inner flow path R11 and the outer flow path R12.

Although the various embodiments have been described above with reference to the drawings, it is needless to say that the present invention is not limited to these examples. It is apparent that those skilled in the art may conceive of various modifications and changes within the scope described in the claims, and it is understood that such modifications and changes naturally fall within the technical scope of the present invention. In addition, respective constituent elements in the above-described embodiment may be freely combined without departing from the gist of the invention.

In this specification, at least the following matters are described. Although corresponding constituent elements or the like in the embodiment described above are shown in parentheses, the present invention is not limited thereto.

(1) A vehicle (vehicle V) including:
a case (battery case 2);
a power device (battery module 3) accommodated in the case; and
a cooling mechanism (cooling mechanism 5) configured to introduce air in a passenger compartment into the case to cool the power device, in which
the cooling mechanism includes
   an exhaust duct (exhaust duct 53) configured to allow the air to be discharged from the case,
the exhaust duct includes
   a first duct portion (first duct portion 531) connected to the case,
   a second duct portion (second duct portion 532) fixed to a floor panel (floor panel F) of the vehicle, and
   a plate-shaped coupling member (coupling member 533) coupling the first duct portion and the second duct portion,
the second duct portion and the coupling member are fixed by a fixing member (clip 533b) passing through a through hole (through hole 533c) of the second duct portion and a through hole (through hole 532d) of the coupling member,
the fixing member is fitted in one of the through hole of the second duct portion or the through hole of the coupling member, and
other of the through hole of the second duct portion or the through hole of the coupling member is longer than the one of the through hole of the second duct portion or the through hole of the coupling member at least in a width direction of the vehicle.

According to (1), by adopting the plate-shaped coupling member, a degree of freedom in forming the flow path is improved, unlike an annular and bellows-shaped coupling member in the conventional art. Further, a positional deviation between the first duct portion and the second duct portion in the vehicle width direction can be absorbed by a slide structure formed by the through hole of the second duct portion and the through hole of the coupling member. Accordingly, when the coupling member coupled to the first duct portion is attached to the second duct portion fixed to a vehicle body, attachment workability is improved.

(2) The vehicle according to (1), in which
the through hole of the coupling member is longer than the through hole of the second duct portion in the width direction of the vehicle.

According to (2), by setting the through hole of the coupling member to be longer in the vehicle width direction than the through hole of the second duct portion, the positional deviation between the first duct portion and the second duct portion in the vehicle width direction can be absorbed.

(3) The vehicle according to (1) or (2), in which
the exhaust duct has
   a first flow path (first flow path R1) along which the air passes through the first duct portion and the second duct portion, and
   a second flow path (second flow path R2) along which the air passes through the first duct portion and does not pass through the second duct portion.

According to (3), the exhaust can be dispersed, and temperature management in the passenger compartment can be facilitated, and the discomfort of the occupant due to the exhaust from the exhaust duct can be eliminated or reduced.

(4) The vehicle according to any one of (1) to (3), in which
the exhaust duct has a first flow path (first flow path R1) along which the air passes through the first duct portion and the second duct portion, and
the second duct portion is a cover member that covers the floor panel (floor panel F) of the vehicle, so that the first flow path is formed between the second duct portion and the floor panel.

According to (4), since an exhaust area is increased, a flow velocity is decreased, and thus generation of abnormal noise can be prevented while controlling the exhaust.

(5) The vehicle according to any one of (1) to (4), in which
a wiring (harness H) is disposed along a front-rear direction of the vehicle between the second duct portion and the floor panel.

According to (5), the second duct portion can have a function of supporting the wiring.

(6) The vehicle according to (5), in which
an exhaust port (exhaust port 531c) of the first duct portion is formed to allow the air to be discharged toward the wiring.

According to (6), the exhaust can be controlled using the wiring.

(7) The vehicle according to (6), in which
as the air hits the wiring, the first flow path is divided into an inner flow path (inner flow path R11) along which the air passes an inner side of the wiring and an outer flow path (outer flow path R12) along which the air passes an outer side of the wiring.

According to (7), the exhaust can be dispersed, and discomfort of the occupant due to air conditioning can be eliminated or reduced.

(8) The vehicle according to any one of (1) to (7), in which the exhaust port of the first duct portion includes a first exhaust port (first exhaust port 531c1) located at a front side of the vehicle and in communication with the inner flow path, and a second exhaust port (second exhaust port 531c2) located rearward of the first exhaust port and in communication with the outer flow path.

According to (8), the exhaust is easily dispersed.

(9) The vehicle according to (3), in which
the second flow path allows the air to pass through a gap that is covered from above by the coupling member and provided between the first duct portion and the second duct portion.

According to (9), the second flow path can be easily formed by not adopting an annular structure.

(10) The vehicle according to (9), in which
the first flow path and the second flow path allow the air to be discharged to different directions in a front-rear direction of the vehicle.

According to (10), the discomfort of the occupant due to the air conditioning can be eliminated or reduced.

### REFERENCE SIGNS LIST

2: battery case (case)
3: battery module (power device)
5: cooling mechanism
53: exhaust duct
531: first duct portion
531c: exhaust port
531c1: first exhaust port
531c2: second exhaust port
532: second duct portion
532d: through hole
533: coupling member
533b: clip
533c: through hole
R1: first flow path
R11: inner flow path
R12: outer flow path
R2: second flow path
F: floor panel
H: harness (wiring)

What is claimed is:

1. A vehicle comprising:
a case;
a power device accommodated in the case; and
a cooling mechanism configured to introduce air in a passenger compartment of the vehicle into the case to cool the power device, wherein
the cooling mechanism includes
an exhaust duct configured to allow the air to be discharged from the case,
the exhaust duct includes
a first duct portion connected to the case,
a second duct portion fixed to a floor panel of the vehicle, and
a plate-shaped coupling member coupling the first duct portion and the second duct portion,
the second duct portion and the coupling member are fixed by a fixing member passing through a through hole of the second duct portion and a through hole of the coupling member,
the fixing member is fitted in one of the through hole of the second duct portion or the through hole of the coupling member, and
other of the through hole of the second duct portion and the through hole of the coupling member is longer than the one of the through hole of the second duct portion or the through hole of the coupling member at least in a width direction of the vehicle.

2. The vehicle according to claim 1, wherein
the through hole of the coupling member is longer than the through hole of the second duct portion in the width direction of the vehicle.

3. The vehicle according to claim 1, wherein
the exhaust duct has
a first flow path along which the air passes through the first duct portion and the second duct portion, and
a second flow path along which the air passes through the first duct portion and does not pass through the second duct portion.

4. The vehicle according to claim 2, wherein
the exhaust duct has
a first flow path along which the air passes through the first duct portion and the second duct portion, and
a second flow path along which the air passes through the first duct portion and does not pass through the second duct portion.

5. The vehicle according to claim 1, wherein
the exhaust duct has a first flow path along which the air passes through the first duct portion and the second duct portion, and
the second duct portion is a cover member that covers the floor panel of the vehicle, so that the first flow path is formed between the second duct portion and the floor panel.

6. The vehicle according to claim 2, wherein
the exhaust duct has a first flow path along which the air passes through the first duct portion and the second duct portion, and
the second duct portion is a cover member that covers the floor panel of the vehicle, so that the first flow path is formed between the second duct portion and the floor panel.

7. The vehicle according to claim 5, wherein
a wiring is disposed along a front-rear direction of the vehicle between the second duct portion and the floor panel.

8. The vehicle according to claim 6, wherein
a wiring is disposed along a front-rear direction of the vehicle between the second duct portion and the floor panel.

9. The vehicle according to claim 7, wherein
an exhaust port of the first duct portion is formed to allow the air to be discharged toward the wiring.

10. The vehicle according to claim 8, wherein
an exhaust port of the first duct portion is formed to allow the air to be discharged toward the wiring.

11. The vehicle according to claim 9, wherein
as the air hits the wiring, the first flow path is divided into an inner flow path along which the air passes an inner side of the wiring and an outer flow path along which the air passes an outer side of the wiring.

12. The vehicle according to claim 10, wherein
as the air hits the wiring, the first flow path is divided into an inner flow path along which the air passes an inner side of the wiring and an outer flow path along which the air passes an outer side of the wiring.

13. The vehicle according to claim 11, wherein
the exhaust port of the first duct portion includes a first exhaust port located at a front side of the vehicle and in communication with the inner flow path, and a second exhaust port located rearward of the first exhaust port and in communication with the outer flow path.

14. The vehicle according to claim 12, wherein
the exhaust port of the first duct portion includes a first exhaust port located at a front side of the vehicle and in communication with the inner flow path, and a second exhaust port located rearward of the first exhaust port and in communication with the outer flow path.

15. The vehicle according to claim 3, wherein
the second flow path allows the air to pass through a gap that is covered from above by the coupling member and provided between the first duct portion and the second duct portion.

16. The vehicle according to claim 4, wherein
the second flow path allows the air to pass through a gap that is covered from above by the coupling member and provided between the first duct portion and the second duct portion.

17. The vehicle according to claim 15, wherein
the first flow path and the second flow path allow the air to be discharged to different directions in a front-rear direction of the vehicle.

18. The vehicle according to claim 16, wherein
the first flow path and the second flow path allow the air to be discharged to different directions in a front-rear direction of the vehicle.
